(19) United States
(12) Patent Application Publication
(10) Pub. No.: US 2003/0020807 A1
(43) Pub. Date: Jan. 30, 2003

(54) Hand-held electronic stereoscopic imaging system with improved three-dimensional imaging capabilities

(76) Inventors: Behrokh Khoshnevis, Marina Del Rey, CA (US); Gregory M. Steinthal, Los Angeles, CA (US)

Correspondence Address: PENNIE AND EDMONDS, 1155 AVENUE OF THE AMERICAS, NEW YORK, NY, 100362711

(21) Appl. No.: 09/912,686

(22) Filed: Jul. 25, 2001

(51) Int. Cl. H04N 13/00

(52) U.S. Cl. 348/42; 348/51; 348/53; 348/47

(57) ABSTRACT

An improved stereoscopic imaging system that includes a pair of image capturing components and a pair of eyepieces, wherein the distance between the image capturing components may be varied substantially independently of the distance between the eyepieces. In a preferred embodiment, the stereoscopic imaging system comprises a housing having two telescope chambers, each telescope chamber containing an objective lens and an image capturing component. The telescope chambers are preferably attached to an adjustment assembly that allows a user to adjust the distance between the chambers and thus the distance between the imaging capturing components contained therein to enhance and vary the 3-D effect of the images captured by the image capturing components. The stereoscopic imaging device also preferably includes internal circuitry that can communicate with a remote system by wire hook-up or by wireless communication.

### FIELD OF THE INVENTION

The present invention relates generally to a hand-held electronic imaging system and, more specifically, to a solid state stereoscopic imaging system with improved three-dimensional (3-D) imaging capabilities.

### BACKGROUND OF THE INVENTION

Conventional binoculars and similar devices produce 3-D images by using two objective lenses spaced apart from one another to capture two views of one scene, each from a distinct angle. However, conventional binoculars do not provide an enhanced adjustable 3-D effect which would result from providing a mechanism to move the objective lenses significantly apart from one another. Instead, in conventional binoculars, the relative positions of each eyepiece and its corresponding objective lens is typically fixed, and the degree to which the objective lenses can be moved apart is limited. Some slight adjustment of the distance between the eyepieces is often possible to suit the various distances between users' eyes, and this often results in a slight change in the distance between the objective lenses; but the purpose is for user comfort, not for enhanced 3-D effect. For example, conventional binoculars sometimes include a pivot mechanism for adjusting the distance between the eyepieces. In addition, U.S. Pat. No. 5,581,399 shows an adjustment assembly for adjusting this distance. In both cases the objective lenses move together with the eyepieces and thus the distance between the objective lenses can be varied only a slight amount.

Therefore, there is a need for an improved stereoscopic imaging system that is free from restrictions imposed by conventional binoculars so that a 3-D effect can be enhanced and varied.

### SUMMARY OF THE INVENTION

It is therefore an object of the present invention to provide a stereoscopic viewing system having enhanced 3-D viewing.

It is another object of the present invention to provide a stereoscopic viewing system in which the 3-D effect can be varied.

It is still another object of the present invention to provide a stereoscopic viewing system in which the distance between the objective lenses can be varied substantially independently of the distance between the eyepieces.

Briefly, the present invention provides an improved stereoscopic imaging system that includes a pair of image capturing components and a pair of eyepieces, wherein the distance between the image capturing components may be varied substantially independently of the distance between the eyepieces. In a preferred embodiment, the stereoscopic imaging system comprises a housing having two telescope chambers, each telescope chamber containing an objective lens and an image capturing component. The telescope chambers are preferably attached to an adjustment assembly that allows a user to adjust the distance between the chambers and thus the distance between the imaging capturing components contained therein to enhance and vary the 3-D effect of the images captured by the image capturing components. Preferably, the captured images are then electronically transmitted to display means for display through two eyepieces. Since images are transmitted electronically to the eyepieces rather than optically using prisms and lenses, the telescope chambers that contain the image capturing components can be moved apart to enhance 3-D imaging without restrictions that would be imposed by optical components.

The image capturing components are preferably solid state imaging sensors, such as, but not limited to, CMOS photo arrays. The image capturing components are preferably connected to a processor, such as a digital signal processor, which, in turn, is connected to a pair of image displaying components, such as liquid crystal displays (LCDs) or other suitable displays. Images received by each image capturing component are converted to electronic signals that are processed by the processor and displayed on corresponding displays. Images displayed on the display means are then viewed through two eyepieces.

Preferably, the stereoscopic imaging system also includes a communication circuit for transmitting and receiving images and other data, such as audio data, to and from one or more remote systems. The communication circuit preferably includes wireless communication capability. Data may, for example, be transmitted to the remote system in real time (i.e., as the images and other data are being captured by the stereoscopic imaging system) or may be transmitted later after the data has been stored in memory in the stereoscopic imaging system.

### BRIEF DESCRIPTION OF THE DRAWINGS

For a more complete understanding of the present invention, reference is made to the following Detailed Description taken in conjunction with the accompanying drawings wherein like reference numerals identify like components and wherein:

FIG. 1 illustrates a preferred stereoscopic imaging system according to the invention;

FIG. 2 illustrates an adjustment assembly for adjusting the distance between the telescope chambers of FIG. 1;

FIG. 3 illustrates internal components of the stereoscopic imaging system of FIG. 1;

FIG. 4 is a block diagram of components in the stereoscopic imaging system of FIG. 1; and

FIG. 5 illustrates the hand-held electronic stereoscopic imaging system of FIG. 1 connected to remote systems via the Internet.

### DETAILED DESCRIPTION OF THE PREFERRED EMBODIMENTS

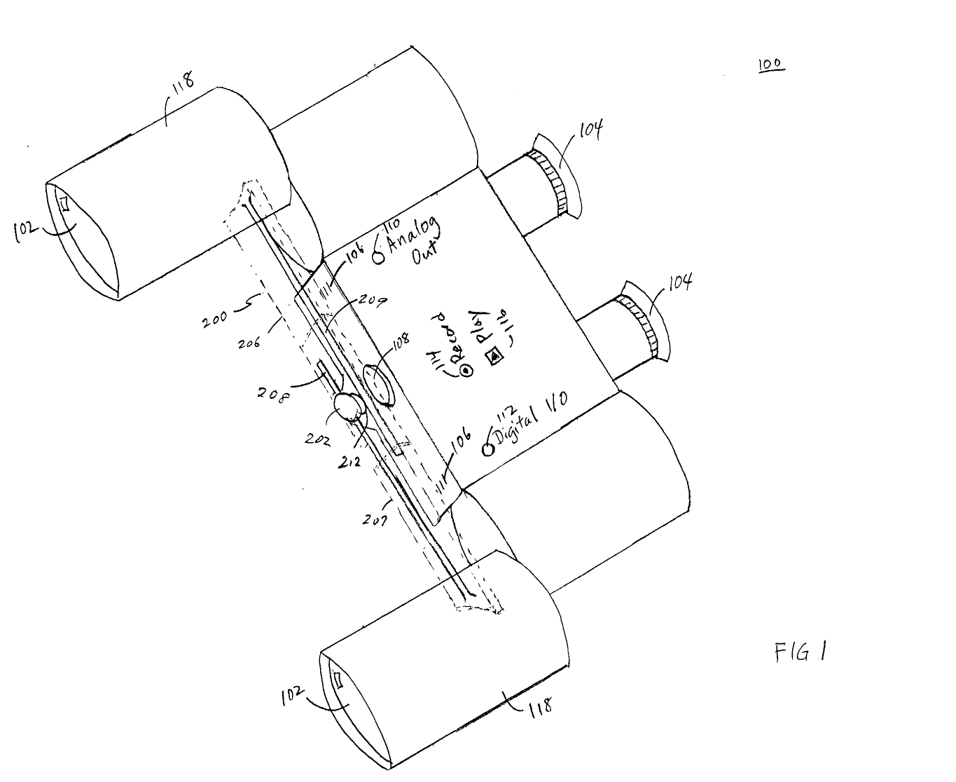

FIG. 1 illustrates a stereoscopic imaging device 100 in accordance with the present invention. As shown in FIG. 1, stereoscopic imaging device 100 preferably includes objective lenses 102, telescope chambers 118, adjustment assembly 200, eyepieces 104, microphones 106, antenna 108, analog output port 110, digital input/output port 112, “record” button 114, and “playback” button 116.

Telescope chambers 118 are attached to an adjustment assembly 200, which in turn permits a user to adjust the distance between the telescope chambers 118 to enhance and vary 3-D imaging.

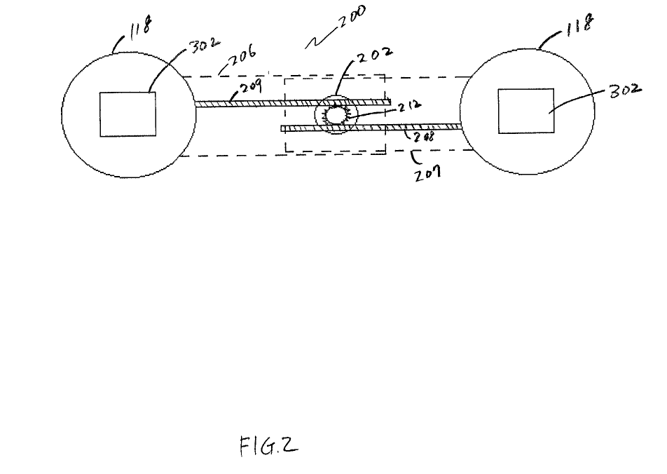

FIG. 2 illustrates adjustment assembly 200 in detail. As shown in FIG. 2, adjustment assembly 200 includes an adjustment knob 202 affixed to gear 212. Screws 208 and 209 are each attached to a telescope chamber 118 on one end and are in operative engagement with gear 212 so that, when gear 212 rotates, screws 208 and 209, and thus the telescope chambers 118, are pulled towards or pushed away from each other. In this way, the distance between telescopic chambers 118 can be varied by rotating knob 202, allowing users to increase and decrease the amount of 3-D effect. Gear 212 and screws 208 and 209 are housed within sliding members 206 and 207 which are each connected to a telescope chamber 118 on one end respectively and are slidably coupled to each other on the other end so that they can slide together or apart to adjust to the movements of telescope chambers 118. In an alternative embodiment, screws 208 and 209 are attached to the sliding members 206 and 207 rather than the telescope chambers 118 so that the screws move telescope chambers 118 indirectly by sliding the sliding members together or apart.

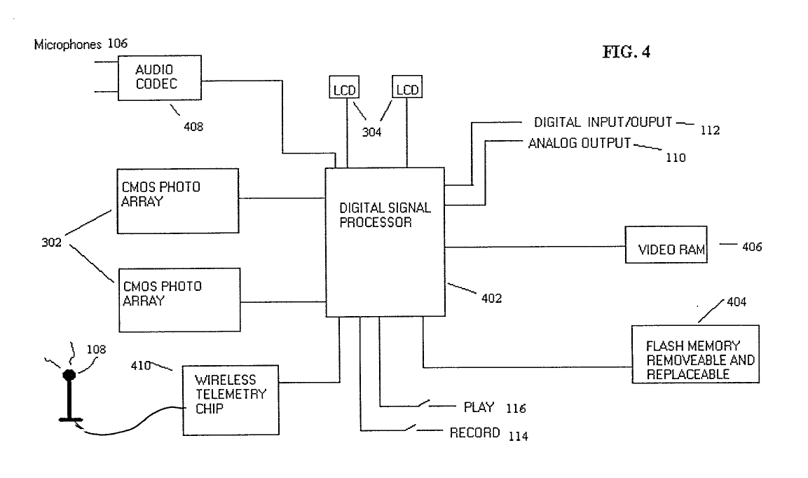

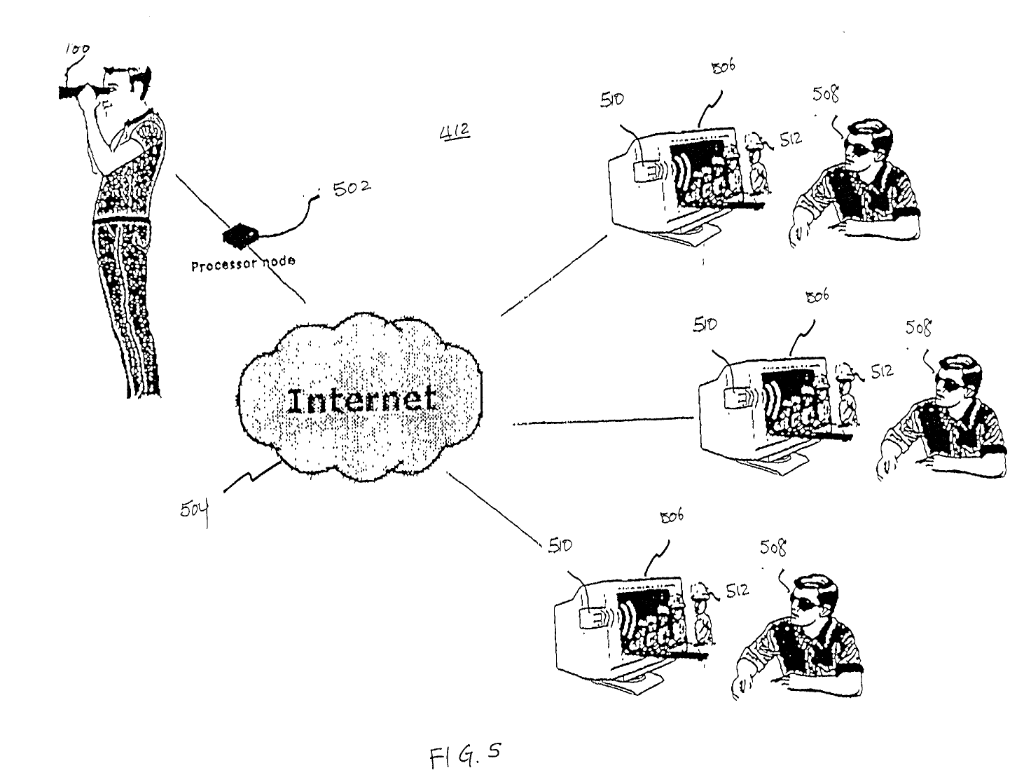

Referring back to FIG. 1, a stereoscopic imaging system in accordance with a preferred embodiment of the present invention also includes eyepieces 104 that magnify images generated within device 100 for viewing by a user. Microphones 106 gather ambient sound for recording in stereo. Antenna 108 is preferably an internal antenna that receives and transmits wireless communication signals between stereoscopic imaging device 100 and other devices such as a remote computer system. Analog output port 110 provides audio output to, e.g., stereo headphones or speakers, which may be connected to the port via a wire hook-up. Digital input/output port 112 provides digital data input and output for downloading digital data for local storage and/or playback and uploading digital data to a remote computer for remote storage and/or playback. Digital data transfer is described in further detail below in connection with FIGS. 4 and 5. “Record” button 114 and “playback” button 116 cause device 100 to begin recording or play back, respectively, of visual and/or audio information.

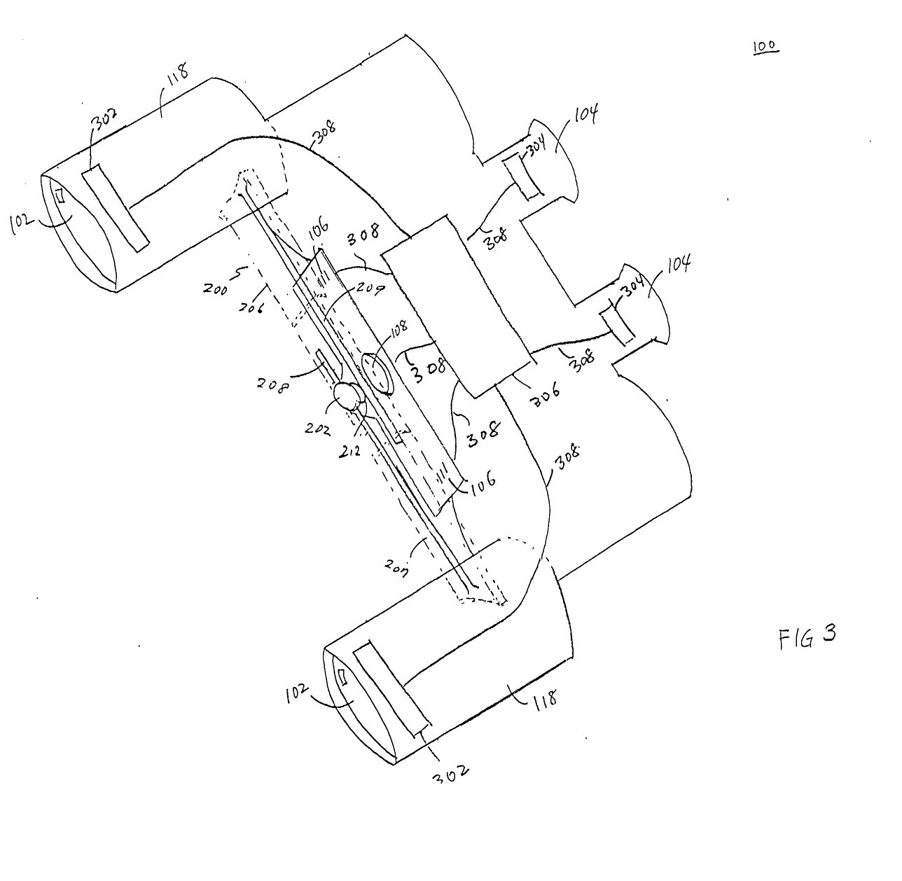

FIG. 3 illustrates the interior of stereoscopic imaging device 100. The interior of stereoscopic imaging device 100 preferably includes CMOS photo arrays 302, liquid crystal displays (LCD) 304, internal circuitry 306, and electrical connections 308. CMOS photo array 302 is an array of light detectors that converts incident light into corresponding electrical signals. There are preferably two CMOS photo arrays 302, each receiving light collected by one of the objective lenses 102. The size of objective lenses 102 determines their light gathering power. A suitable CMOS array is the Smart Vision CMOS Color Sensor. There are preferably two LCDs 304, one visible through each eyepiece 104. A suitable LCD is the Cyberdisplay 320 Mono made by Kopin. Eyepieces 104 magnify the images displayed on LCDs 304 to facilitate viewing by a user. Electrical connections 308 connect each CMOS photo array 302, LCD 304, and other components to internal circuitry 306.

As depicted in FIG. 3, the present invention electronically captures images of objects and then electronically recreates the images on displays for viewing. By capturing and displaying images electronically, device 100 is free from the constraints imposed by the lenses and prisms included in optically-based imaging devices such as conventional binoculars, allowing telescope chambers 118, and thus CMOS photo arrays 302, to be separated much farther apart than conventional binoculars. Since the difference in the angle of perception of the objective lenses can be greater in a device in accordance with the present invention, the 3-D effect in viewed images can be enhanced and varied.

FIG. 4 is a block diagram of internal components in a stereoscopic imaging system in accordance with a preferred embodiment of the present invention. The components preferably include digital signal processor 402, flash memory 404, random access memory 406, audio processor 408, and wireless telemetry chip 410.

Digital signal processor (DSP) 402 preferably enables and disables CMOS photo arrays 302, LCDs 304, and microphones 106. DSP 402 may also perform signal processing on the signals received from CMOS photo arrays 302, such as image compression, image stabilization (if, for example, the magnification power of the objective lens and eyepiece is high enough to cause image distortions), color correction, and other signal processing tasks, as are known in the art. DSP 402 also sends signals to LCDs 304, which in turn generate images in accordance with the received signals. In addition, DSP 402 preferably regulates communication between various components of stereoscopic imaging device 100 and communication between device 100 and external devices. A suitable digital signal processor is the Hitachi SH-3 SH7709A, which has image stabilization capabilities. Random access memory 406 serves as a temporary memory for DSP 402 during signal processing. A suitable random access memory is the SDRAM # MT48LC16M16A2TG-8E made by Micron Semiconductors.

Audio processor 408 converts analog sounds received by microphones 106 into digital signals, which are then sent to DSP 402. Flash memory 404 stores visual and audio data produced by stereoscopic imaging system 100 or received from external sources. Before storing visual and audio data in flash memory 404, DSP 402 associates visual data captured by CMOS photo arrays 302 with the corresponding audio data captured by microphones 106 and audio processor 408. DSP 402 decompresses data where necessary when playing back image and audio data stored in flash memory 404.

Wireless telemetry chip 410 is connected to antenna 108 and modulates signals received from DSP 402 for wireless transmission through antenna 108 to remote devices. In addition, wireless telemetry chip 410 demodulates wireless signals from remote devices and sends them to DSP 402. A suitable telemetry chip is made by Blue Tooth.

Turning now to FIG. 5, stereoscopic imaging device 100 preferably transmits and receives visual and audio data to and from processor node 502 via wireless transmission. Alternatively, processor node 502 may be connected by wire hook-up to device 100 through digital input/output 112. Processor node 502, in turn, preferably connects to a plurality of computers 506 through the Internet 504 or some other network. Data can thus be transmitted from stereoscopic imaging device 100 to computers 506 via processor node 502. The transmission may be performed in real time so that remote users can view and hear images and sounds simultaneously with the user of stereoscopic imaging device 100. Alternatively, the transmitted visual and audio data may be data previously stored within flash memory 404. Computer 506 may also transmit visual and audio data to stereoscopic imaging device 100 via the Internet 504 and processor node 502. The data transmitted to stereoscopic imaging device 100 may be played back as it is being downloaded or the data may be stored in flash memory 404 for playback at a later time.

Each computer 506 preferably includes a display and speakers for displaying and playing back visual and audio data sent from device 100. Computer 506 preferably includes the proper hardware and software to multiplex the right and left eye video information so that remote viewers may view the images in 3-D using stereoscopic eyewear 508. Such eyewear may have polarized lenses, as is known in the art. Alternatively, 3-D images may be viewed on specialized 3-D monitors without the use of 3-D eyewear. Such monitors are manufactured by DTI.

While the invention has been described in conjunction with specific embodiments, it is evident that numerous alternatives, modifications, and variations will be apparent to those skilled in the art in light of the forgoing descriptions. For example, different adjustment mechanisms may be used for adjusting the distance between the objective lenses. Additionally, a separate mechanism may be provided for adjusting the distance between the eyepieces which is independent or substantially independent of the mechanism for adjusting the distance between the objective lenses. The scope of this invention is defined only by the following claims.

What is claimed is:

1. A stereoscopic imaging system comprising:
an adjustment assembly;
a first lens mounted to the adjustment assembly;
a second lens mounted to the adjustment assembly;
a first eyepiece for viewing images received by the first lens;
a second eyepiece for viewing images received by the second lens;
wherein the distance between the first and second lenses can be varied by the adjustment assembly and wherein the distance between the first and second lenses is substantially independent of the distance between the first and second eyepieces.

2. The stereoscopic imaging system of claim 1 wherein the first lens and second lens are housed in a first and second telescope chamber, respectively, and wherein the first and second telescope chambers are attached to the adjustment assembly.

3. A stereoscopic imaging system of claim 1 further comprising:
a first image capturing component in an optical path behind the first lens that produces first image signals;
a second image capturing component in an optical path behind the second lens that produces second image signals;
a processor coupled to the first and second image capturing components that receives the first and second image signals and produces one or more resultant signals corresponding to the first and second image signals; and
display means that displays the resultant signals.

4. The stereoscopic imaging system of claim 3 wherein the first and second image capturing components comprise first and second CMOS photo arrays, respectively.

5. The stereoscopic imaging system of claim 1 wherein the first and second lenses comprise first and second objective lenses, respectively.

6. The stereoscopic imaging system of claim 3 wherein the display means comprises first and second displays.

7. The stereoscopic imaging system of claim 3 further comprising a wireless communication circuit coupled to the processor that enables the processor to transmit and receive data by wireless communication.

8. The stereoscopic imaging system of claim 3 wherein the processor comprises a digital signal processor.

9. The stereoscopic imaging system of claim 3 further comprising flash memory coupled to the processor.

10. The stereoscopic imaging system of claim 3 further comprising random access memory coupled to the processor.

11. The stereoscopic imaging system of claim 3 further comprising an audio processor coupled to the processor.

12. The stereoscopic imaging system of claim 11 further comprising a first microphone and second microphone coupled to the audio processor.

13. The stereoscopic imaging system of claim 3 further comprising an analog output port connected to the processor.

14. The stereoscopic imaging system of claim 3 further comprising a digital input/output port connected to the processor.

15. The stereoscopic imaging system of claim 3 further comprising a remote system in communication with the processor.

16. The stereoscopic imaging system of claim 7 further comprising a remote system in communication with the processor.

17. The stereoscopic imaging system of claim 16 wherein the remote system comprises a processor node and at least one remote device wherein the processor node facilitates communication between the processor and the remote device.

18. The stereoscopic imaging system of claim 17 wherein the processor node communicates with the processor via the wireless communication circuit.

19. The stereoscopic imaging system of claim 17 wherein the processor node communicates with the processor via wire hook-up.

20. The stereoscopic imaging system of claim 17 wherein the remote device is capable of communicating with the processor node through the Internet.

21. The stereoscopic imaging system of claim 17 wherein the remote device further comprises a display for displaying visual data in 3-D.

22. The stereoscopic imaging system of claim 17 wherein the remote device further comprises a display and a pair of stereoscopic eyewear that allows viewers to view images generated by the display in 3-D.

23. The stereoscopic imaging system of claim 17 wherein the remote device further comprises speakers.

24. A stereoscopic imaging system, comprising:
an adjustment assembly;
a first telescope chamber attached to the adjustment assembly;
a second telescope chamber attached to the adjustment assembly;
a first eyepiece for viewing images received by the first telescope chamber;
a second eyepiece for viewing images received by the second telescope chamber;
wherein the distance between the first and second telescope chambers can be varied by the adjustment assembly substantially independently of the distance between the first and second eyepieces.
